(19) United States
(12) Patent Application Publication
(10) Pub. No.: US 2019/0129585 A1
(43) Pub. Date: May 2, 2019

(54) INFORMATION PROCESSING APPARATUS, NON-TRANSITORY RECORDING MEDIUM STORING CONTROL PROGRAM, AND CONTROL METHOD

(71) Applicant: SHARP KABUSHIKI KAISHA, Osaka (JP)

(72) Inventors: TAKASHI SAWANO, Sakai City (JP); MAYUKO YOSHIDA, Sakai City (JP); KUMIKO OGINO, Sakai City (JP); YASUHIRO NAKAI, Sakai City (JP); MASAO SAEDA, Sakai City (JP)

(21) Appl. No.: 16/178,362

(22) Filed: Nov. 1, 2018

(30) Foreign Application Priority Data
Nov. 1, 2017 (JP) 2017-212192

(51) Int. Cl. G06F 3/0482; G06F 3/0481; G06F 3/0484; G06Q 30/02

(52) U.S. Cl. CPC G06F 3/0482; G06Q 30/0283; G06F 3/0484; G06F 3/04817

(57) ABSTRACT

An information processing apparatus includes a display. The display displays a first home screen for selecting a job and two or more operation screens for setting a set condition of the job. The two or more operation screens include a setting change operation screen including a change icon for changing the set condition, after the set condition of the job is set. When the change icon is touched on the setting change operation screen, the set condition of the job is changed.

### BACKGROUND

### 1. Field

The present disclosure relates to an information processing apparatus, a non-transitory recording medium storing a control program, and a control method, and in particular, to an information processing apparatus, a non-transitory recording medium storing a control program, and a control method that receive user operations via graphical user interface (GUI), for example.

### 2. Description of the Related Art

An example of the related art is disclosed in Japanese Unexamined Patent Application Publication No. 2012-129836. An image forming apparatus in the related art includes an operation unit including a hardware key and a touch screen, and a display and receives a user operation via a GUI which is displayed on the display. When a certain job (copy job or the like) is performed in such image forming apparatus, the user sets the job by operating the operation unit, and then, starts the certain job by pressing a start key provided in the operation unit.

However, in some cases in the image forming apparatus in the related art, the setting of the job may not be as that desired by the user. In such a case, the user is requested to perform again the setting of job from the beginning, which is troublesome. Therefore, there is a room for improvement in order for the convenience.

Therefore, the present disclosure is to provide an information processing apparatus, a non-transitory recording medium storing a control program, and a control method.

Furthermore, the present disclosure is to provide an information processing apparatus, a non-transitory recording medium storing a control program, and a control method that can improve the convenience.

### SUMMARY

According to an aspect of the disclosure, there is provided an information processing apparatus including a touch panel display, a condition setting unit, a storage unit, a display control unit, a condition changing unit, and a condition updating unit. The condition setting unit sets a set condition for a service provided by the information processing apparatus in response to an input operation on the touch panel display. The storage unit stores setting data corresponding to the set condition set by the condition setting unit. The display control unit causes a setting change operation screen including a change icon for changing the set condition to be displayed on the touch panel display after the setting data is stored in the storage unit. The condition changing unit changes the set condition in accordance with the input operation on the touch panel display when the change icon is selected. The condition updating unit updates the setting data stored in the storage unit in accordance with the set condition changed by the condition changing unit.

According to another aspect of the disclosure, there is provided a non-transitory recording medium storing a control program for an information processing apparatus including a touch panel display and a storage. The control program causes a processor of the information processing apparatus to function as: a condition setting unit that sets a predetermined set condition for the information processing apparatus in response to an input operation on the touch panel display; a storage unit that causes the storage to store setting data corresponding to the set condition set by the condition setting unit; a display control unit that causes a setting change operation screen including a change icon for changing the set condition to be displayed on the touch panel display after the setting data is stored in the storage; a condition changing unit that changes the set condition in accordance with the input operation on the touch panel display when the change icon is selected; and a condition updating unit that updates the setting data stored in the storage in accordance with the set condition changed by the condition changing unit.

According to still another aspect of the disclosure, there is provided a control method executable by a processor of an information processing apparatus including a touch panel display and a storage, the method including: setting a predetermined set condition for the information processing apparatus in response to an input operation on the touch panel display; causing the storage to store set setting data corresponding to the set condition in the storage; causing a setting change operation screen including a change icon for changing the set condition to be displayed on the touch panel display after the setting data is stored in the storage; changing the set condition in accordance with a user operation when the change icon is selected, and updating the setting data stored in the storage in accordance with the set condition after the change.

### BRIEF DESCRIPTION OF THE DRAWINGS

FIG. 1 is an illustrative diagram illustrating an external configuration of an information processing system according to an embodiment of the present disclosure;

FIG. 2 is a block diagram illustrating an electrical configuration of an information processing apparatus illustrated in FIG. 1;

FIG. 3 is a block diagram illustrating an electrical configuration of an image forming apparatus illustrated in FIG. 1;

FIG. 4 is an illustrative diagram illustrating an example of a first home screen;

FIG. 5 is an illustrative diagram illustrating an example of a first copy setting screen;

FIG. 6 is an illustrative diagram illustrating an example of a second copy setting screen;

FIG. 7 is an illustrative diagram illustrating an example of a third copy setting screen;

FIG. 8 is an illustrative diagram illustrating an example of a first guide screen;

FIG. 9 is an illustrative diagram illustrating an example of a second guide screen;

FIG. 10 is an illustrative diagram illustrating an example of a memory map of RAM in the information processing apparatus illustrated in FIG. 2;

FIG. 11 is an illustrative diagram illustrating an example of a memory map of RAM in the image forming apparatus illustrated in FIG. 3;

FIG. 12 is a flowchart illustrating an example of information processing performed by a CPU illustrated in FIG. 2;

FIG. 13 is an illustrative diagram illustrating an example of a copy check screen according to a second embodiment;

FIG. 14 is an illustrative diagram illustrating an example of a first scan setting screen;

FIG. 15 is an illustrative diagram illustrating an example of a second scan setting screen;

FIG. 16 is an illustrative diagram illustrating an example of a third scan setting screen;

FIG. 17 is an illustrative diagram illustrating an example of a fourth scan setting screen;

FIG. 18 is an illustrative diagram illustrating an example of a scan check screen;

FIG. 19 is a flowchart illustrating an example of information processing in the second embodiment;

FIG. 20 is an illustrative diagram illustrating an example of a first notification screen according to a third embodiment;

FIG. 21 is an illustrative diagram illustrating an example of a second notification screen in the third embodiment;

FIG. 22 is a flowchart illustrating a part of an example of information processing in the third embodiment;

FIG. 23 is an illustrative diagram illustrating an example of a first selection screen according to a fourth embodiment;

FIG. 24 is an illustrative diagram illustrating an example of a third guide screen in the fourth embodiment;

FIG. 25 is an illustrative diagram illustrating an example of a second selection screen in the fourth embodiment; and

FIG. 26 is a flowchart illustrating an example of information processing in the fourth embodiment.

### DESCRIPTION OF THE EMBODIMENTS

### First Embodiment

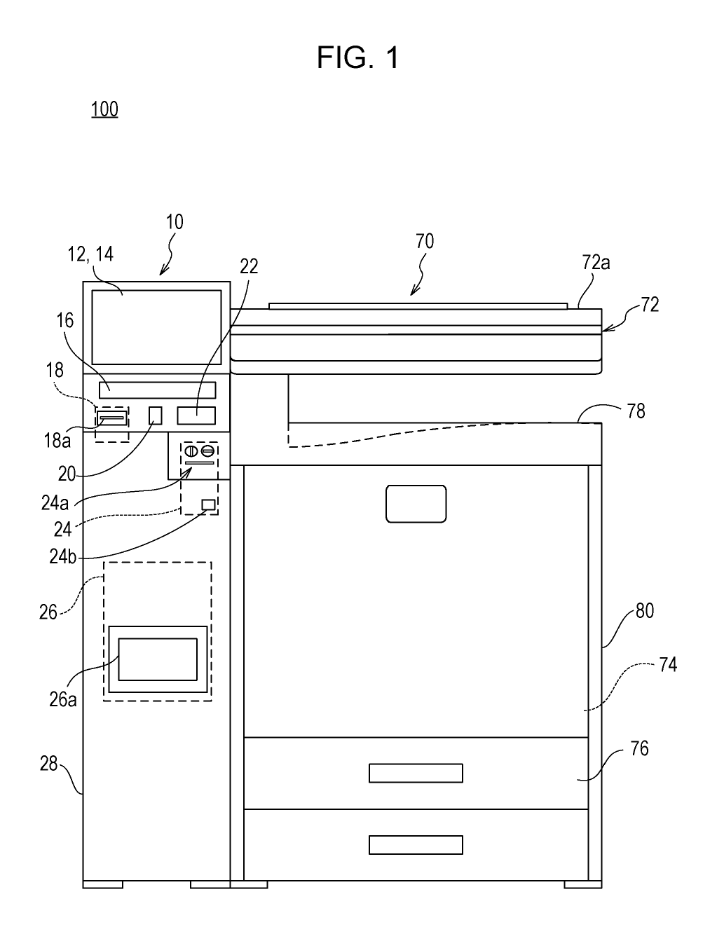

FIG. 1 is an illustrative diagram illustrating an example of a configuration of an information processing system 100 according to the present disclosure. With reference to FIG. 1, the information processing system 100 in the first embodiment of the present disclosure includes an information processing apparatus 10 and an image forming apparatus 70.

The information processing apparatus 10 is a multimedia kiosk (MMK) terminal disposed in stores such as a supermarket, a restaurant or a convenience store, and in public facilities such as a station, a bus terminal, an airport, a government office, or a library. The information processing apparatus 10 provides various kinds of information or predetermined services to users in accordance with the location where they are placed. Further, the information processing apparatus 10 can cooperate with the image forming apparatus 70 and provide predetermined services to the user such as copying, printing, scanning and faxing, which will be described later in detail.

In this specification, the front and rear direction (depth direction) of the information processing apparatus 10 and configuration members thereof is defined with the surface facing the standing position of the user, that is, a surface on the side on which the display 14 described later is provided as a front side (front face), and the right and left direction (lateral direction) of the information processing apparatus 10 and the configuration members thereof is defined on the basis of the state of viewing the information processing apparatus 10 from the user. This definition will also be applied to the image forming apparatus 70.

The information processing apparatus 10 includes an apparatus body 28 that includes the display 14 with a touch panel 12, a recording medium connection unit 16, a printer 18 for paper slip, a code reading unit 20, a local area communication unit 22, a money treatment unit 24, and a printer 26 for photographs.

The display 14 with the touch panel 12 is disposed on an upper end portion of the information processing apparatus 10 (apparatus body 28). The touch panel 12 is a general-purpose touch panel, and any types of touch panels such as an electrostatic capacity type, an electromagnetic induction type, a resistive film type, an infrared type, or the like can be used. In the first embodiment, the electrostatic capacity type is used as the touch panel 12, and the touch panel 12 is provided on the display surface of the display 14. However, a touch panel display in which the touch panel 12 and the display 14 are integrally formed may be used. In addition, for example, an LCD or an electro-luminescence (EL) display or the like can be used as the display 14.

The recording medium connection unit 16 includes a mounting portion (for example, a drive and a memory slot) for mounting various recording media. Various recording media are optical disks (for example, a CD-R, a DVD-R and a BD-R) and flash memories (for example, a USB memory, an SD card, a memory stick, and the like). However, the optical disk is mounted on the drive. Also, the flash memory is mounted on the memory slot.

The printer 18 for paper slip is, for example, a thermal printer or a dot impact printer, and issues a paper slip such as a receipt, a journal or a coupon. Specifically, the printer 18 for paper slip prints various character strings, images, code patterns (such as barcodes), and the like on the roll paper, and discharges the printed paper slips from the paper discharge unit 18a.

The code reading unit 20 includes, for example, a laser scanner or a camera, and can read a code attached to a product, a card, a receipt, or the like or a code displayed on a screen of a user terminal (portable terminal). The codes that can be read by the code reading unit 20 includes a bar code (one-dimensional bar code) or two-dimensional code (for example QR Code®, a micro QR code, a DataMATRIX, a MaxiCODE, a VeriCODE, and the like).

The local area communication unit 22 performs wireless non-contact data communication with a communication target such as an electronic money medium, an IC card (an identification card, a membership card, an employee ID card, or the like), a user terminal or the like in accordance with a communication protocol such as ISO/IEC 18092 or the like (so-called near field communication (NFC)). The communicable distance of the local area communication unit 22 is approximately several centimeters to several meters. The local area communication unit 22 transmits a signal (read command) instructing to read data stored in the communication target to the communication target. The communication target transmits desired data to the local area communication unit 22 in response to the read command. In addition, the local area communication unit 22 transmits a signal (write command) for instructing writing together with data (write data) to be written into the communication target. The communication target writes (stores) the received write data to the storage of the communication target in accordance with the write command.

The money treatment unit 24 includes a money insert slot 24a and a coin return port 24b. The money insert slot 24a includes a coin insert slot, a banknote insert slot, a change return lever, and the like, and is disposed below the local area communication unit 22. The coins inserted from the coin insert slot and the banknotes inserted from the banknote insert slot are categorized for each type and are accommodated in a predetermined money storage unit (not illustrated). The money storage unit includes a coin storage portion and a banknote storage portion. When the coins or the banknotes are inserted, the inserted amount is calculated in accordance with the type and number of coins accommodated in the coin storage portion and the type and number of banknotes accommodated in the banknote storage portion. When a predetermined service or the like is performed in the information processing apparatus 10, the cost corresponding to the content of the service is subtracted from the inserted amount, and then, a balance of the inserted amount is calculated. In addition, when the change return lever is operated, the coins or banknotes are returned depending on the balance of the inserted amount. However, the coins are returned from the coin return port 24b provided on the lower portion of the money insert slot 24a, and the banknotes are returned from the banknote insert slot.

The printer 26 for photographs is, for example, a sublimation type printer or an ink jet printer, and prints an image on paper for photographs (photographic paper). The photograph printed by the printer 26 for photographs is discharged to a discharge unit 26a. Image data stored in the recording medium connected to the recording medium connection unit 16 or image data transmitted from the external computer or the like is used as the image data for forming the image on the paper. Sizes of the photographs printed by the printer 26 for photographs are L size, postcard size, 2L size, or the like.

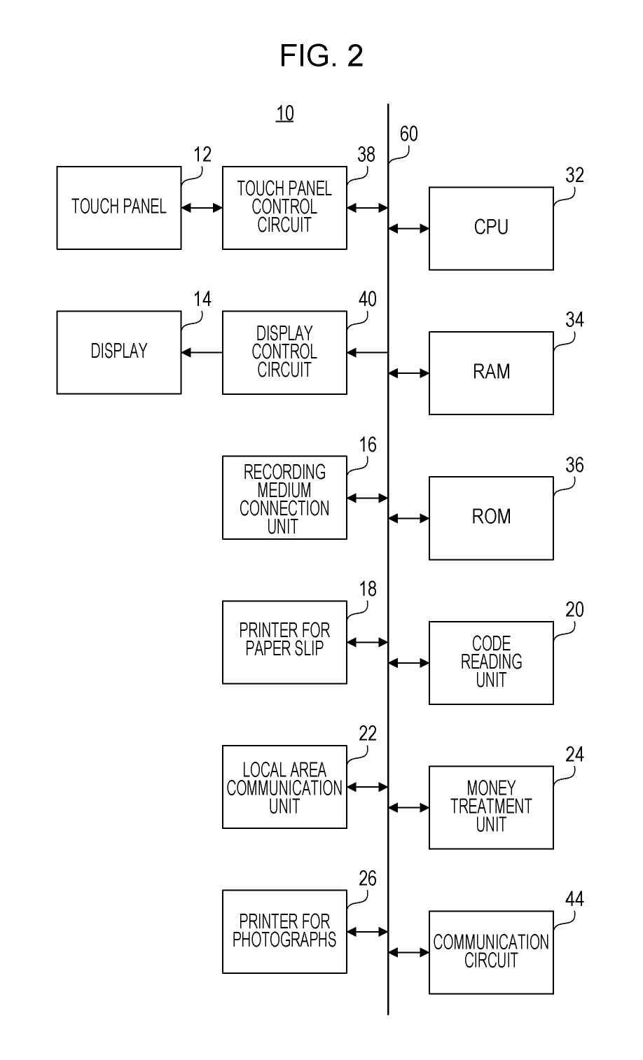

FIG. 2 is a block diagram illustrating an electrical configuration of the information processing apparatus 10 illustrated in FIG. 1. Referring to FIG. 2, the information processing apparatus 10 includes a CPU 32. A RAM 34, a ROM 36, a touch panel control circuit 38, a display control circuit 40, a recording medium connection unit 16, a printer 18 for paper slip, a code reading unit 20, a local area communication unit 22, a money treatment unit 24, a printer 26 for photographs and a communication circuit 44 are connected to a CPU 32 via a bus 60. In addition, a touch panel 12 is connected to the touch panel control circuit 38, and a display 14 is connected to the display control circuit 40.

The CPU 32 performs overall control of the information processing apparatus 10. The RAM 34 is used as a work area and a buffer area of the CPU 32. The ROM 36 stores default values for the start program of the information processing apparatus 10 and various kinds of information.

The touch panel control circuit 38 gives requested voltage and the like to the touch panel 12, detects a touch input within the touch effective range of the touch panel 12, and outputs touch coordinate data to the CPU 32.

The display control circuit 40 includes a GPU, a VRAM, and the like, and the GPU generates display image data for displaying display image data for displaying various screens on the display 14 in the VRAM under the instruction from the CPU 32 using the image generation data stored in the RAM 34, and outputs the generated display image data to the display 14.

The communication circuit 44 is a communication circuit for a connection to a network such as the Internet. The communication circuit 44 is a wired communication circuit or a wireless communication circuit, and communicates with an external computer (external terminal) such as a server via a network in accordance with an instruction from the CPU 32. However, the communication circuit 44 may also directly communicate with the image forming apparatus 70, the user terminal, or the like in a wired or wireless manner (for example, an infrared method, a WiFi® method, or a Bluetooth® method) not via the network.

The electrical configuration of the information processing apparatus 10 illustrated in FIG. 2 is merely an example, and the present disclosure is not limited thereto.

Returning to FIG. 1, the image forming apparatus 70 is a multifunction peripheral (MFP) having a copying function, a printer function, a scanner function, a facsimile function and the like.

The image forming apparatus 70 includes an apparatus body 80 including an image reading unit 72, an image forming unit 74, a paper feeder 76, and a paper discharge tray 78. However, the image forming apparatus 70 is installed in the vicinity of the information processing apparatus 10. For example, the image forming apparatus 70 is provided adjacent to the right side of the information processing apparatus 10.

The image reading unit 72 includes a document table formed of a transparent material, and is built in the apparatus body 80. A document pressing cover 72a is attached on the upper portion of the document table via a hinge or the like in a freely openable and closable manner.

In addition, the image reading unit 72 includes a light source, mirrors, an imaging lens, a line sensor, and the like. The image reading unit 72 exposes the surface of the document to a light source and guides the reflection light reflected from the surface of the document to the imaging lens by the mirrors. Then, the reflection light is focused on the light receiving element of the line sensor by the imaging lens. In the line sensor, the brightness or the chromaticity of the reflection light focused on the light receiving element is detected, and the read image data based on the image of the surface of the document is generated. A charge coupled device (CCD), a contact image sensor (CIS) or the like is used as the line sensor.

The image forming unit 74 is built in the apparatus body 80 and provided on the lower portion of the image reading unit 72. The image forming unit 74 includes a photosensitive drum, a charging device, an exposure device, a developing device, a transfer device, a fixing device, and the like. The image forming unit 74 forms an image on a recording medium (paper) transported from a paper feeder 76 or the like using an electro-photographic method, and discharges the paper on which the image is formed to the paper discharge tray 78 provided between the image reading unit 72 and the image forming unit 74. However, as the image data for forming an image on the paper, the read image data read by the image reading unit 72, the image data transmitted from the information processing apparatus 10, the image data transmitted from an external computer, and the like are used. In addition, the recording medium is not limited to paper made of paper, but sheets other than the paper such as OHP film are also used.

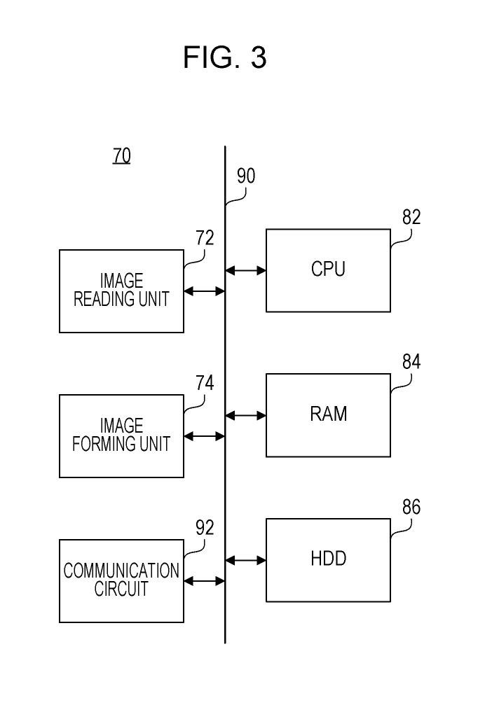

FIG. 3 is a block diagram illustrating an electrical configuration of the image forming apparatus 70 illustrated in FIG. 1. Referring to FIG. 3, the image forming apparatus 70 includes a CPU 82. A RAM 84, an HDD 86, an image reading unit 72, an image forming unit 74, and a communication circuit 92 are connected to the CPU 82 via a bus 90.

The CPU 82 performs overall control of the image forming apparatus 70. The RAM 84 is used as a work area and a buffer area of the CPU 82.

The HDD 86 is a main storage unit of the image forming apparatus 70, and appropriately stores a control program for the CPU 82 to control the operation of each part of the image forming apparatus 70 and display image data to be displayed on various screens and the like. However, other nonvolatile memories such as an SSD, a flash memory, an EEPROM and the like may be used in place of or together with the HDD 86.

The communication circuit 92 is a communication circuit for the connection to a network such as the Internet. The communication circuit 92 is a wired communication circuit or a wireless communication circuit, and communicates with an external computer (external terminal) such as a server via a network in accordance with an instruction from the CPU 82. However, the communication circuit 92 may also directly communicate with the information processing apparatus 10, in a wired or wireless manner not via the network.

The electrical configuration of the image forming apparatus 70 illustrated in FIG. 3 is merely an example, and the present disclosure is not limited thereto.

In the information processing system 100 having such a configuration, the user operation is received via the GUI displayed on the display 14 of the information processing apparatus 10. For example, in the information processing apparatus in the related art, when a certain job (copy job or the like) is performed, the user operates the operation unit and sets the set condition of the certain job. Thereafter, when a start key or the like provided in the operation unit is pressed, the job is started in accordance with the set condition of the job set by the user. Hereinafter, the user operation for setting the set condition of the job may be referred to as a setting operation.

However, in the information processing apparatus in the related art, when a user who is not accustomed to using the apparatus performs the setting operation, the set condition of the job may not be the set condition that desired by the user. In this case, in the information processing apparatus in the related art, the setting of the job needs to be performed again from the beginning, which is troublesome.

In addition, if the set condition is not the set condition desired by the user, the user operation different from the set condition of the job may be performed. In such a case, the user operation may become an error and the job is hard to be started. As described above, the image forming apparatus in the related art has a room for improvement in order for the convenience.

Therefore, in the first embodiment, after the set condition of the job is set, a setting change operation screen that includes a change icon for changing the set condition is displayed on the display 14 of the information processing apparatus 10.

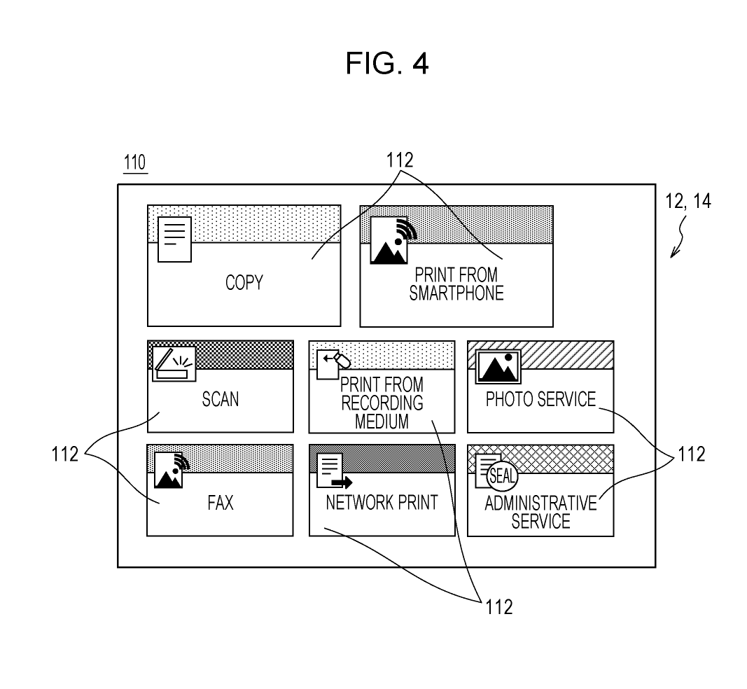

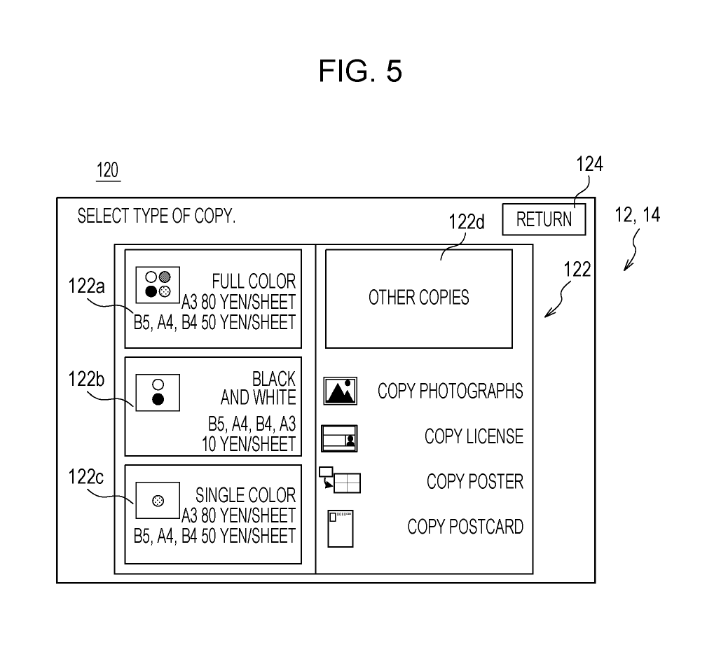

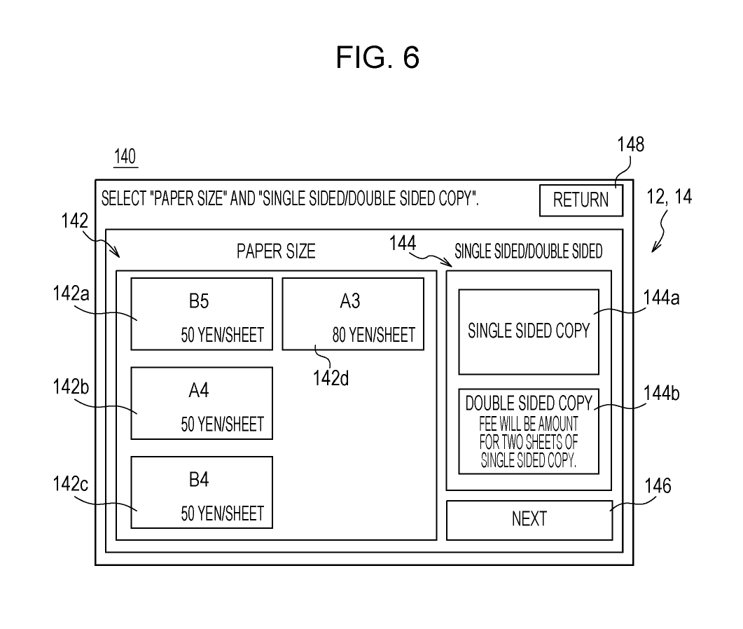

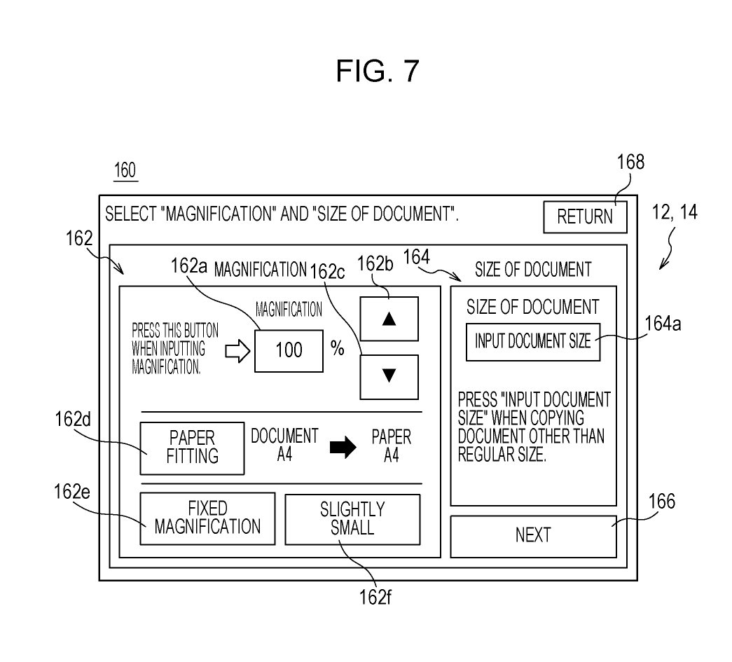

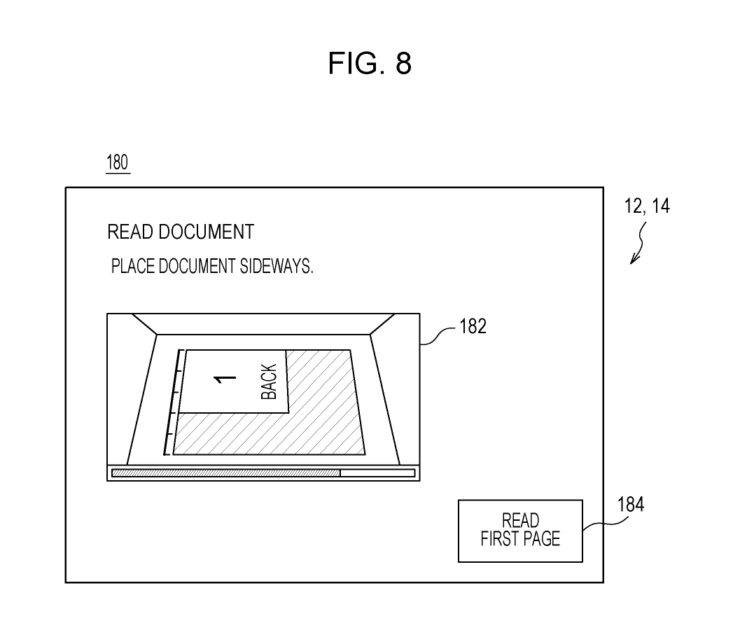

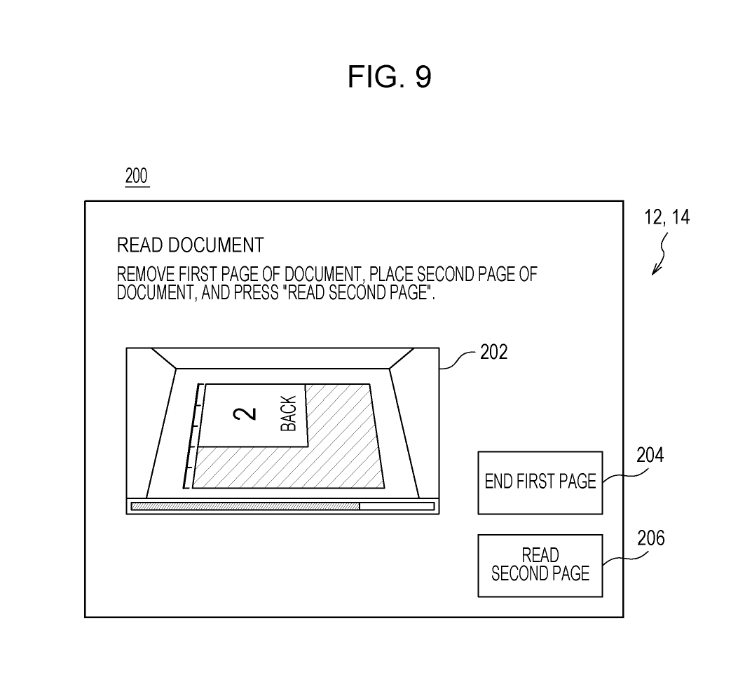

Hereinafter, an operation example of the information processing system 100 will be described with reference to FIG. 4 to FIG. 9. FIG. 4 is an illustrative diagram illustrating an example of a home screen 110. FIG. 5 is an illustrative diagram illustrating an example of a first copy setting screen 120. FIG. 6 is an illustrative diagram illustrating an example of a second copy setting screen 140. FIG. 7 is an illustrative diagram illustrating an example of a third copy setting screen 160. FIG. 8 is an illustrative diagram illustrating an example of a first guide screen 180. FIG. 9 is an illustrative diagram illustrating an example of a second guide screen 200.

When main power suppliers of the information processing apparatus 10 and the image forming apparatus 70 are turned on and are in a standby state such that various jobs (services) can be performed, a home screen 110 as illustrated in FIG. 4 is displayed on the display 14 of the information processing apparatus 10.

The home screen 110 is an operation screen for selecting various jobs. However, in the first embodiment, the job means copy, scan, print, fax transmission, and the like. In the home screen 110, icons 112 for selecting each job are provided (displayed).

Each of the icons 112 is an image enclosed by a substantially rectangular frame and functions as a software key. To each of the icons 112, the jobs such as “copy”, “scan”, “fax”, “print from a recording medium”, “network print”, “photo service”, “administrative service”, and “print from a smartphone” are assigned.

When any icon 112 included in the home screen 110 is touched (selected), two or more operation screens (setting screens) for setting two or more setting items included in the set condition of the job assigned to the icon 112 are sequentially displayed on the display 14. For example, when an icon 112 to which a copy job is assigned is touched, as a first operation screen for setting the set condition of the job, the first copy setting screen 120 illustrated in FIG. 5 is displayed on the display 14.

The first copy setting screen 120 includes a setting area 122 and a return icon 124. The setting area 122 is an area for setting the type of copy job such as color mode. In this setting area 122, icons 122a, 122b, 122c, 122d are provided. The setting for a color copy (full color) is assigned to the icon 122a. The setting for a black and white copy (monochrome) is assigned to the icon 122b. The setting for a single color copy is assigned to the icon 122c. To the icon 122d, the settings for special copying types other than the above-described types are assigned. As the special copying, photocopies, copies of licenses, creation (copies) of posters and copies of postcards are included. In each of the icons 122a to 122c, an amount of fee per one copy of the corresponding copy job is displayed. However, with regard to the icon 122d, since the amount of the fee varies depending on the types of the copy, the first copy setting screen 120 does not display the amount of fee per one copy.

The function of closing the first copy setting screen 120 and returning to the previous operation screen is assigned to the return icon 124. For example, when the return icon 124 is touched, the first copy setting screen 120 is closed (non-displayed) and the home screen 110 is displayed on the display 14. In addition, when the return icon 124 is touched, the set condition of the job is initialized. The same is applied to return icons 148, 168, 244, 264, 288, and 308 which will be described later.

In the first copy setting screen 120, the type of copy job is set by touching any one of the icons 122a to 122d. When the type of copy job is set, the display on the display 14 is switched to the next operation screen. For example, when the type of copy job is set in the first copy setting screen 120, a second copy setting screen 140 illustrated in FIG. 6 is displayed on the display 14.

The second copy setting screen 140 is a screen for setting the size of the paper (printing paper) to be printed and setting of single sided copy/double sided copy, and includes a first setting area 142, a second setting area 144, a next icon 146, and a return icon 148.

The first setting area 142 is an area for setting the size of the paper to be printed. In the first setting area 142, icons 142a to 142d are provided. Setting for using B5 size paper is assigned to the icon 142a. Setting for using A4 size paper is assigned to the icon 142b. Setting for using B4 size paper is assigned to the icon 142c. Setting for using A3 size paper is assigned to the icon 142d. In addition, in each of the icons 142a to 142d, the amount of fee per one sheet when corresponding paper is used is displayed. However, the amount of fee displayed on the icons 142a to 142d differs depending on the type of copy job. The amount of fee displayed on the icons 142a to 142d illustrated in FIG. 6 is the amount in a case where the type of copy job is “color copy”.

The second setting area 144 is an area for setting the single sided copy/double sided copy. In the second setting area 144, an icon 144a and an icon 144b are provided. Setting of the single sided copy is assigned to the icon 144a. Setting of the double sided copy is assigned to the icon 144b. In addition, when double sided copy is selected, a message indicating that the fee will become the amount for two sheets of single sided copy is displayed in the icon 144b.

In the second copy setting screen 140, the size of the paper to be printed is temporarily determined by touching any one of the icons 142a to 142d, and whether the single sided copy is performed or the double sided copy is performed is temporarily determined by touching one of the icon 144a and the icon 144b. When the icons 142a to 142d, and the icon 144a and the icon 144b are touched, the display mode changes. Although not illustrated, a pattern is added to the touched icon or an appropriate color is added. In this way, the user can recognize the icon selected by him/herself, and can recognize the set condition temporarily determined by him/herself.

The function of fixing (determining) the temporarily determined set condition and proceeding to the next operation screen is assigned to the next icon 146. The same is applicable to the next icons 166, 286, and 304 to be described later. For example, when the next icon 146 is touched, the setting of the size of paper to be printed and the setting of single sided copy/double sided copy are determined, and then, the second copy setting screen 140 is closed and the third copy setting screen 160 is displayed on the display 14 as illustrated in FIG. 7.

The third copy setting screen 160 is a screen for setting a copy magnification and a document size, and includes a first setting area 162, a second setting area 164, a next icon 166, and a return icon 168.

The first setting area 162 is an area for setting the copy magnification (magnification of the size of the print image). A text box 162a is provided in the first setting area 162. In the text box 162a, a numerical value indicating the copy magnification is displayed. The numerical value displayed in the text box 162a changes as the icon 162b or icon 162c disposed on the right side of the text box 162a is touched. However, a function of making the numerical value displayed in the text box 162a large (increasing) is assigned to the icon 162b, and a function of making the numerical value displayed in the text box 162a small (decreasing) is assigned to the icon 162c.

Icons 162d to 162f are provided in the first setting area 162. A function of automatically setting the copy magnification according to the size of the paper to be printed is assigned to the icon 162d. A function of setting the copy magnification to a preset fixed magnification is assigned to the icon 162e. A function of setting the copy magnification to be slightly smaller (for example, 95%) is assigned to the icon 162f.

In this first setting area 162, a numerical value is input to the text box 162a or one of the icons 162d to 162f is touched, and then, the copy magnification is temporarily determined.

The second setting area 164 is an area for setting the size of the document. An icon 164a is provided in the second setting area 164. A function of displaying an input screen (not illustrated) for setting the size of the document is assigned to the icon 164a. When the icon 164a is touched, an input screen for inputting the document size is displayed, and the document size is set (temporarily determined) in accordance with the user operation.

In the third copy setting screen 160, when the next icon 166 is touched, setting of temporarily determined copy magnification and the document size is determined. In addition, when the next icon 166 is touched, the third copy setting screen 160 is closed and a guide screen for reading the document is displayed on the display 14. For example, a first guide screen 180 illustrated in FIG. 8 is displayed on the display 14. In this first embodiment, the third copy setting screen 160 is the last operation screen for setting the set condition of the job. Therefore, when the icon 166 in the third copy setting screen 160 is touched, it means that a set condition for performing the copy job has been set.

The first guide screen 180 is a screen for guiding the way how to place a document and read the first page of the document. A message informing the user of the way how to place the document, and a rectangular moving image display area 182, and an instruction icon 184 are provided in the first guide screen 180.

For example, in the first guide screen 180, a message saying “Place the document sideways” is displayed.

In the moving image display area 182, a moving image indicating a method of setting the document is displayed. Specifically, a moving image indicating the orientation and position (corner of the left back corner) of the document is displayed in the moving image display area 182. However, the moving image is repeatedly reproduced (displayed) until the instruction icon 184 is touched.

The way how to place the document is presented to the user by the message and the moving image displayed in the moving image display area 182. Therefore, the user can appropriately place the document on the table glass while referring to the way how to place the document displayed on the first guide screen 180.

A function of causing the image reading unit 72 of the image forming apparatus 70 to read (scan) the first page of the document is assigned to the instruction icon 184. When the instruction icon 184 is touched, the first page of the document is scanned by the image reading unit 72.

If the number of document is one, when the first page of the document is scanned by the image reading unit 72, a check screen including a preview image and a settlement screen for performing settlement are sequentially displayed on the display 14. When the settlement is completed, the copy job is performed in accordance with the set condition of the job set in each operation screen.

However, if the number of pages of the document is plural such cases as the “double sided copy” is set as the setting of “single sided copy/double sided copy” or if the plural pages is set as the set condition of the job, when the instruction icon 184 is touched in first guide screen 180, the first page of the document is scanned, and then, the second guide screen 200 illustrated in FIG. 9 is displayed on the display 14.

The second guide screen 200 is a screen for guiding the way how to place the document and for reading the second page of the document, and a message guiding the user the way how to place the document, a moving image display area 202, a change icon 204, and an instruction icon 206 are displayed thereon. Since the content of the moving image display area 202 is the similar to that of the moving image display area 182 of the first guide screen 180, the description thereof will be omitted.

A function of changing the set condition of the job is assigned to the change icon 204. Specifically, a function of setting the “single sided copy” as a set condition of single sided copy/double sided copy is assigned to the change icon 204. Therefore, when the change icon 204 is touched, the set condition of single sided copy/double sided copy is changed from the “double sided copy” to the “single sided copy”, and the set condition of the job is updated (overwritten). Therefore, when the change icon 204 is touched, in accordance with the updated set condition of the job, the operation screen proceeds to the screen such as the check screen including the preview image without performing the scanning of the second page of the document. As described above, since the change icon 204 for changing the set condition of the job is provided, the second guide screen 200 is also the setting change operation screen.

A function of causing the image reading unit 72 of the image forming apparatus 70 to read (scan) the second page of the document is assigned to the instruction icon (corresponding to a continue icon) 206. When the instruction icon 206 is touched, the image reading unit 72 scans the second page of the document. If the number of pages of the document is two, when the second page of the document is scanned by the image reading unit 72, the check screen, the settlement screen, and the like are sequentially displayed on the display 14. On the other hand, if the number of pages of the document is three or more, a guide screen for reading the third and subsequent pages of the document is sequentially displayed on the display 14.

The operation of the information processing system 100 as described above is realized by the CPU 32 of the information processing apparatus 10 executing the information processing program for the information processing apparatus 10 stored in the RAM 34, and the CPU 82 of the image forming apparatus 70 executing the information processing program for the image forming apparatus 70 stored in the RAM 84. Specific processing will be described later with reference to a flowchart.

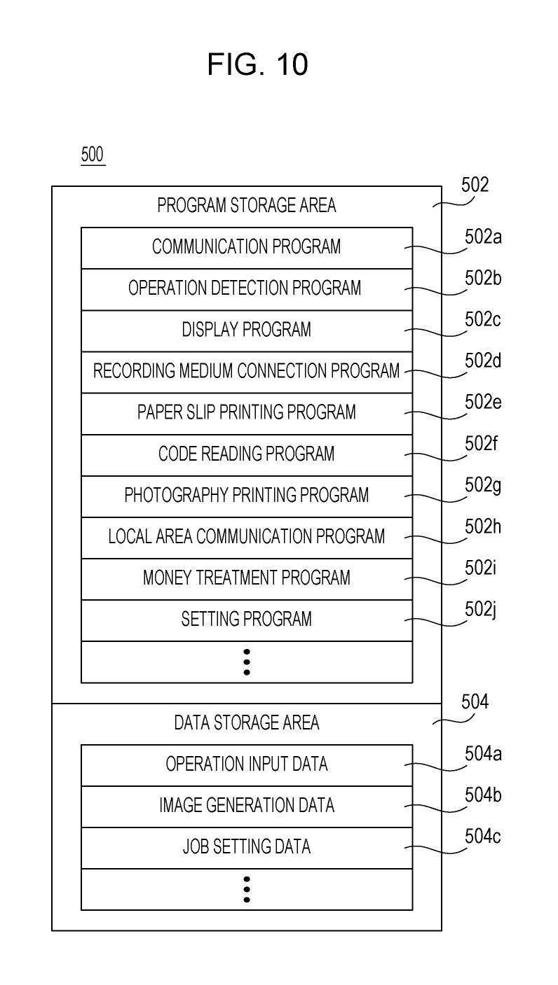

FIG. 10 is an illustrative diagram illustrating an example of a memory map 500 of the RAM 34 in the information processing apparatus 10 illustrated in FIG. 2. As illustrated in FIG. 10, the RAM 34 includes a program storage area 502 and a data storage area 504. In the program storage area 502 of the RAM 34, an information processing program for the information processing apparatus 10 is stored as described above. The information processing program for the information processing apparatus 10 includes a communication program 502a, an operation detection program 502b, a display program 502c, a recording medium connection program 502d, a paper slip printing program 502e, a code reading program 502f, a photography printing program 502g, a local area communication program 502h, a money treatment program 502i, and a setting program 502j.

The communication program 502a is a program for communicating (transmitting and receiving) the data with the image forming apparatus 70, another computer such as a server, or another apparatus, via a network.

The operation detection program 502b is a program for detecting the touch input, and the CPU 32 acquires the touch coordinate data output from the touch panel 12 in accordance with the operation detection program 502b, and stores the acquired touch coordinate data in the RAM 34 in time series. In addition, the operation detection program 502b is a program for acquiring the touch coordinate data output from the touch panel 12 and for detecting the fact that the software keys (icons) included in various operation screens displayed on the display 14 has been operated.

The display program 502c is a program for generating the display image data, that is, the screen data such as the various operation screens described above, using the image generation data 504b to be described later, and for outputting the screen data to the display 14.

The recording medium connection program 502d is a program for controlling writing of the data into various recording media mounted on the recording medium connection unit 16 and reading of the data from the various recording media.

The paper slip printing program 502e is a program for controlling the printer 18 for paper slip to print the character strings, images, bar codes, and the like on the roll paper.

The code reading program 502f is a program for controlling the code reading unit 20 to extract a code image from a captured image captured by a laser scanner or a camera and to decode the extracted code image.

The photography printing program 502g is a program for controlling the printer 26 for photographs to print an image on the photographic paper.

The local area communication program 502h is a program for controlling the local area communication unit 22 and realizing the data communication with a communication target such as a user terminal.

The money treatment program 502i is a program for controlling the money treatment unit 24 to calculate the inserted amount according to the type and number of coins accommodated in the coin storage portion and the type and number of banknotes accommodated in the banknote storage portion. In addition, the money treatment program 502i is a program for controlling the money treatment unit 24 to return the coin from the coin return port 24b or to return the banknote from the banknote insert slot in accordance with the remaining balance amount after subtracting the fee for performing the predetermined job from the inserted amount.

The setting program 502j is a program for setting the set condition of the job according to the user operations (setting operations) in two or more operation screens for setting the set condition of the job, and setting job setting data 504c corresponding to the set condition of the job. In addition, the setting program 502j is also a program for updating the job setting data 504c by changing the set condition of the job according to the user operation (changing operation) on the setting change operation screen.

Although not illustrated, in the program storage area 502, a program for setting a fee for performing the job in the information processing system 100 and a program for selecting and performing various functions of the information processing apparatus 10 are also stored.

In addition, in the data storage area 504 of the RAM 34, operation input data 504a, image generation data 504b, job setting data 504c, and the like are stored.

The operation input data 504a is data in which the touch coordinate data detected in accordance with the operation detection program 502b is stored in time series.

The image generation data 504b is data such as polygon data or texture data for generating the display image data corresponding to various screens displayed on the display 14.

The job setting data 504c is data corresponding to the set condition of the job which is generated or updated in accordance with the setting program 502j.

Although not illustrated, in the data storage area 504, other data for executing the information processing program for the information processing apparatus 10 are stored, and timers (counters) and registers for executing the information processing program for the information processing apparatus 10 are provided.

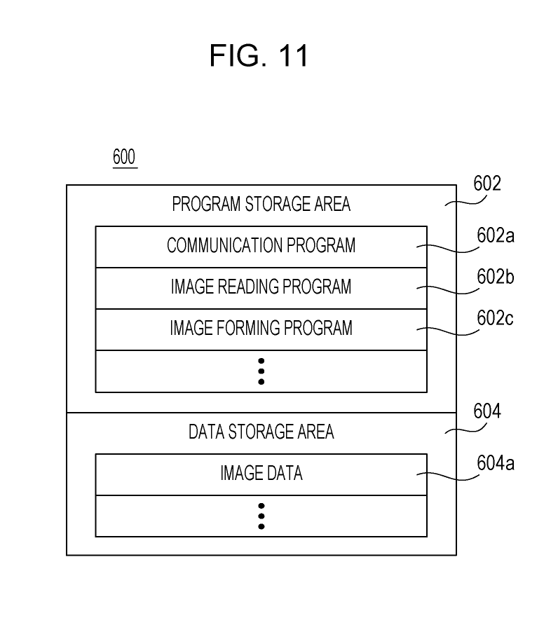

FIG. 11 is an illustrative diagram illustrating an example of a memory map 600 of the RAM 84 in the image forming apparatus 70 illustrated in FIG. 3. As illustrated in FIG. 11, the RAM 84 includes a program storage area 602 and a data storage area 604. In the program storage area 602 of the RAM 84, as described above, the information processing program for the image forming apparatus 70 is stored. The information processing program for the image forming apparatus 70 includes a communication program 602a, an image reading program 602b, and an image forming program 602c.

The communication program 602a is a program for communicating with the information processing apparatus 10, another computer such as a server, or another device via a network.

The image reading program 602b is a program for controlling the image reading unit 72 to read (scan) the image of the document placed on the document table and output the image signal (scanned image data) corresponding to the read image.

The image forming program 602c is a program for controlling the image forming unit 74 to form multicolor or monochrome images on the recording medium (paper) according to image data 604a such as the scanned image data or the input image data.

Although not illustrated, programs and the like for selecting and performing various functions of the image forming apparatus 70 are also stored in the program storage area 602.

In the data storage area 604 of the RAM 84, image data 604a and the like are stored. The image data 604a is image data read by the image reading unit 72 or image data input from an external computer such as a server.

Although not illustrated, in the data storage area 604, other data for executing the information processing program for the image forming apparatus 70 are stored, and timers (counters) and registers for executing the information processing program for the image forming apparatus 70 are provided.

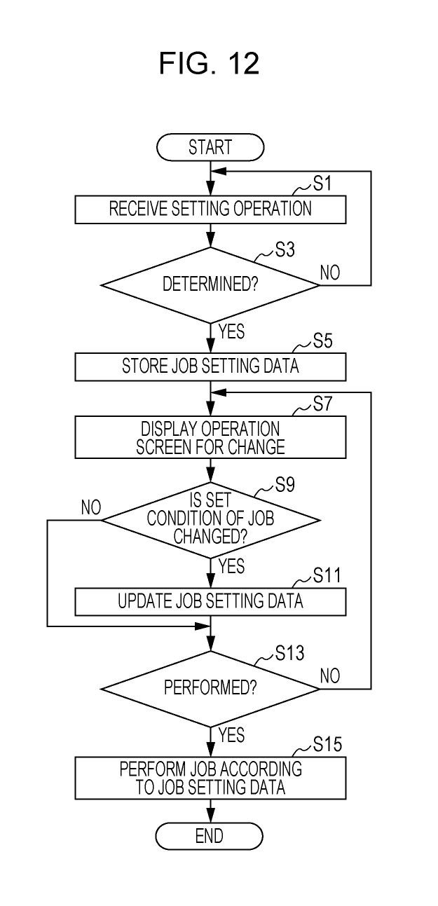

FIG. 12 is a flowchart illustrating an example of information processing performed by the CPU 32 of the information processing apparatus 10 illustrated in FIG. 2. This information processing starts when any icon 112 is touched on the home screen 110 and the job desired by the user is determined.

As illustrated in FIG. 12, when the information processing starts, the CPU 32 of the information processing apparatus 10 receives the setting operation in STEP S1 and makes the process proceed to STEP S3. In STEP S1, as described above, two or more operation screens for setting the set condition of the job are displayed on the display 14, and the set condition of the job is set in accordance with the setting operation of the user.

Subsequently, in STEP S3, it is determined whether or not the set condition of the job is determined. Here, it is determined whether or not the set condition of the job that can be set in the last operation screen is determined among the two or more operation screens for setting the set condition of the job.

If “NO” in STEP S3, that is, if it is determined that the set condition of the job is not determined, the process returns to STEP S1. On the other hand, if “YES” in STEP S3, that is, if it is determined that the set condition of the job is determined, in STEP S5, the job setting data 504c is stored in the RAM 34 of the information processing apparatus 10, and in STEP S7, the operation screen for change is displayed. In STEP S7, for example, as in the second guide screen 200 described above, an operation screen including the change icon for changing the set condition of the job is displayed.

Subsequently, in STEP S9, it is determined whether or not the set condition of the job is changed. Here, it is determined whether or not the change icon (for example, the change icon 204, or the like) for changing the set condition of the job is selected from the operation screen for change.

If “YES” in STEP S9, that is, if it is determined that the set condition of the job is changed, the job setting data 504c is updated in STEP S11, and the process proceeds to STEP S13. On the other hand, if “NO” in STEP S9, that is, if it is determined that the set condition of the job is not changed, the process proceeds to STEP S13 without going through STEP S11.

Subsequently, in STEP S13, it is determined whether or not the job is performed. Here, it is determined whether or not the settlement is completed. If “NO” in STEP S13, that is, if it is determined that the settlement is not completed, the process returns to STEP S7. On the other hand, if “YES” in STEP S13, that is, if it is determined that the settlement is completed, in STEP S15, the job is performed in accordance with the job setting data 504c and the information processing ends.

In the first embodiment, after the set condition of the job is set, the setting change operation screen including the change icon for changing the set condition is displayed on the display 14 of the information processing apparatus 10. For this reason, there is no need to perform the setting again from the beginning, and thus, it is possible to improve the convenience.

In the first embodiment, the job setting data 504c is stored in the RAM 34 of the information processing apparatus 10, but not limited thereto. For example, as in a case of “photo service”, with regard to the jobs that can be performed only by the information processing apparatus 10, the job setting data 504c is stored in the RAM 34 of the information processing apparatus 10, however, as in a case of “copy” and “scan”, with regard to the jobs mainly performed by the image forming apparatus 70, the job setting data 504c may be stored in the RAM 84 of the image forming apparatus 70.

### Second Embodiment

An information processing system 100 according to a second embodiment is similar to that in the first embodiment except that a check screen (a preview screen) including a preview image is displayed after the set condition of the job is set and the change icon is displayed on the check screen, and thus, only the content different from that in the first embodiment will be described and the redundant description will be omitted.

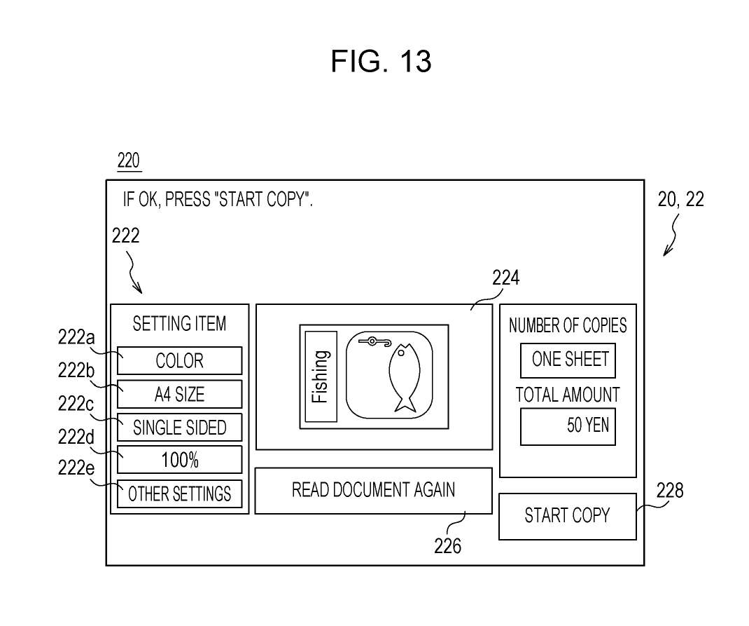

FIG. 13 is an illustrative diagram illustrating an example of a copy check screen 220 in the second embodiment. In the second embodiment, when a guide screen such as the first guide screen 180 and the second guide screen 200 described in the first embodiment is instructed to scan the document, a check screen for checking the set condition of the job or the like is displayed on the display 14. For example, a copy check screen 220 as shown in FIG. 13 is displayed on the display 14.

The copy check screen 220 is a screen for checking and changing the set condition of the job and the like set by various operation screens described above, and includes a change area 222, a preview area 224, a re-scan icon 226 and a start icon 228.

The change area 222 is an area for checking and changing the set condition of the job. In the change area 222, change icons 222a to 222e corresponding to each of two or more setting items are provided. A function of changing the setting of the type of copy job is assigned to the change icon 222a. A function of changing the setting of the size of the printed paper is assigned to the change icon 222b. A function of changing the setting of the single sided copy/double sided copy is assigned to the change icon 222c. A function of changing the setting of the copy magnification is assigned to the change icon 222d. A function of changing the setting of other set conditions is assigned to the change icon 222e.

When any one of the change icons 222a to 222e is touched, a setting change operation screen for changing the set condition corresponding to that icon is displayed on the display 14. For example, when the change icon 222a is touched, the first copy setting screen 120 is displayed on the display 14 to change the setting of the type of copy job. In addition, when the change icon 222b or the change icon 222c is touched, the second copy setting screen 140 is displayed on the display 14 to change the setting of the size of the printed paper or the setting of the single sided copy/double sided copy. Furthermore, when the change icon 222d is touched, the third copy setting screen 160 is displayed on the display 14 to change the setting of the copy magnification. Each operation screen displayed as the setting change operation screen is the same as the normal operation screen displayed when the user performs the setting operation. The arrangement and the function of the icon in the setting change operation screen are also the same as those in the normal operation screen. Therefore, even when the setting change operation screen is displayed on the display 14, the user can perform the changing operation in the same way as when performing the setting operation. In addition, when the set condition of the job changed in the setting change operation screen is determined, the setting change operation screen is closed and the copy check screen 220 is displayed on the display 14.

Furthermore, a character string indicating the current set condition of the job is displayed in the change icons 222a to 222d. For example, when the type of copy job is set to “color copy”, a character string such as “color” is displayed on the change icon 222a. Similarly, a character string indicating the size of the paper to be printed is displayed on the change icon 222b, a character string indicating the setting of the single sided copy/double sided copy is displayed on the change icon 222c, and a character string (numerical value) indicating the setting of the copy magnification displayed on the change icon 222d. In this way, the user can confirm the current set condition of the job.

In the preview area 224, an image (preview image) of the document read by the image reading unit 72 is displayed. However, in the preview area 224, the preview image corresponding to the set condition of the job is displayed. For example, in the preview area 224, if the type of the copy job is set to “color copy”, the color preview image is displayed, and if the type of the copy job is set to “black and white copy”, a two valued black and white or a gray scale preview image is displayed. This will also be applied to a preview area 324 which will be described later.

A function of instruction to read the document again is assigned to the re-scan icon 226. When the re-scan icon 226 is touched, a guide screen (for example, the first guide screen 180) for reading the document is displayed on the display 14. This will also be applied to a re-scan icon 326 described later.

A function of instruction to perform the job is assigned to the start icon (equivalent to continue icon) 228. When the start icon 228 is touched, the process proceeds to the settlement screen or the like for performing the settlement, and when the settlement is completed, the job (copy job in the example illustrated in FIG. 13) is performed in accordance with a set condition of the job. This will also be applied to a start icon 328 described later.

Although detailed description is omitted, an area for changing the number of copies to be copied and an area for displaying the amount of fee are provided in the copy check screen 220.

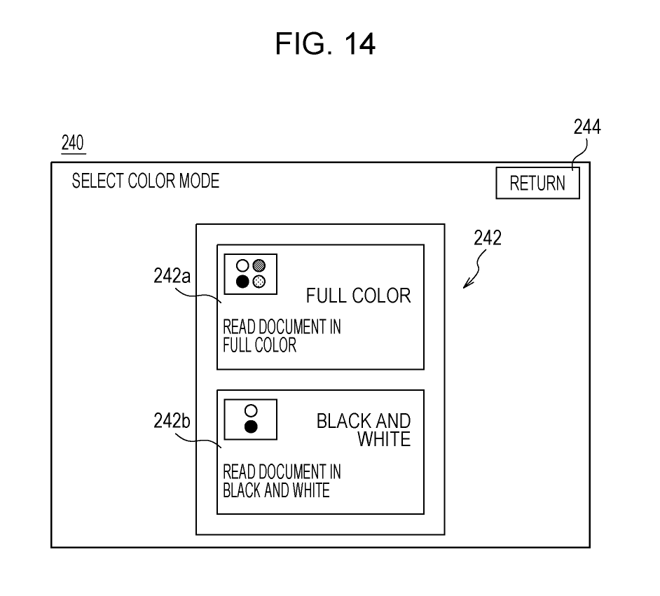

Up to this, the case where the copy job is selected has been described as an example, but the same is also applied to a case where another job such as a scan job or the like is selected. When the icon 112 to which the scan job is assigned is touched on the home screen 110, two or more operation screens for setting two or more setting items included in the set condition of the scan job are displayed on the display 14. For example, a first scan setting screen 240 as illustrated in FIG. 14 is displayed on the display 14 as a first operation screen for setting the set condition of the scan job.

The first scan setting screen 240 is a screen for setting the color mode of the scan job and includes a setting area 242 and a return icon 244. An icon 242a and an icon 242b are provided in the setting area 242. Setting for reading the document in full color is assigned to the icon 242a. Setting for reading the document in black and white is assigned to the icon 242b.

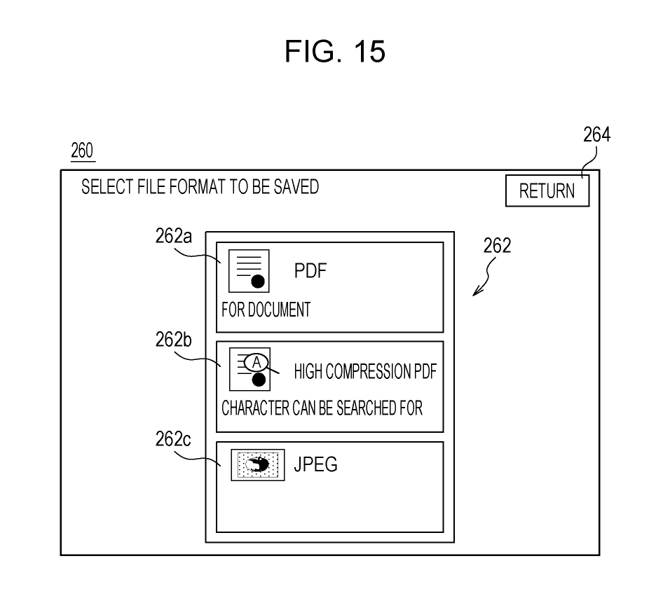

In the first scan setting screen 240, any one of the icon 242a and the icon 242b is touched, the scan job is set as the color mode. When the scan job is set as the color mode, a second scan setting screen 260 as illustrated in FIG. 15 is displayed on the display 14.

The second scan setting screen 260 is a screen for setting a file format of scanned read image data, and includes a setting area 262 and a return icon 264. Icons 262a to 262c are provided in the setting area 262. Setting for saving the read image data in a PDF format is assigned to the icon 262a. Setting for saving the read image data in a high compression PDF format is assigned to the icon 262b. Setting for saving the read image data in a JPEG format is assigned to the icon 262c.

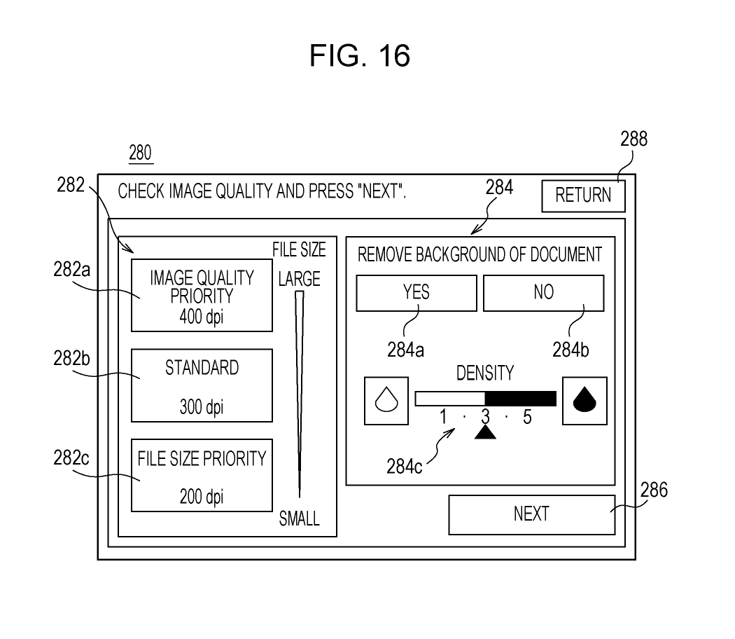

In the second scan setting screen 260, the file format of the read image data is set by touching any one of the icons 262a to 262c. When the file format of the read image data is set, a third scan setting screen 280 illustrated in FIG. 16 is displayed on the display 14.

The third scan setting screen 280 is a screen for setting an image quality of the read image, and includes a first setting area 282, a second setting area 284, a next icon 286, and a return icon 288.

The first setting area 282 is an area for setting the overall image quality of the read image. Icons 282a to 282c are provided in the first setting area 282. A high resolution setting (for example, 400 dpi) is assigned to the icon 282a. A standard resolution setting (for example, 300 dpi) is assigned to the icon 282b. A low resolution setting (for example, 200 dpi) is assigned to the icon 282c.

The second setting area 284 is an area for setting the density of the background of the document (background density). In the second setting area 284, an icon 284a, an icon 284b, and an adjustment slide 284c are provided. Removal of the background density, that is, setting for making the background density white is assigned to the icon 284a. The setting not to remove the background density is assigned to the icon 284b. The adjustment slide 284c includes a bar extending in the right-left direction and a slider moved in the right-left direction along the bar. The slider is moved by an operation (for example, slide operation) by a user. In the adjustment slide 284c, the background density is adjusted by moving (changing) the position of the slider. When the position of the slider of the adjustment slide 284c is moved to the left side, the background density is decreased. In addition, when the position of the slider of the adjustment slide 284c is moved to the right side, the background density is increased. In the third scan setting screen 280, the user can set the background density by selecting the icon 284a or the icon 284b, or by moving the position of the slider of the adjustment slide 284c.

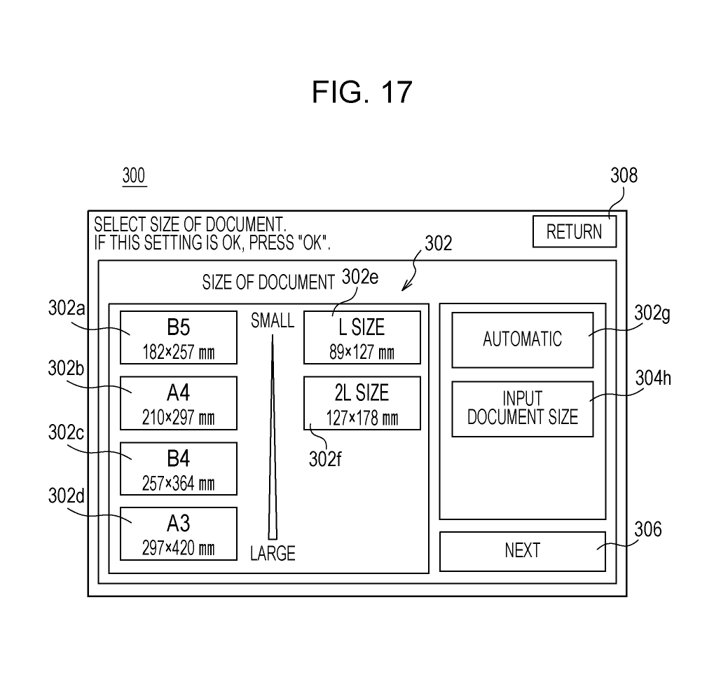

In the third scan setting screen 280, when the next icon 286 is touched, the image quality of the read image is determined. When the image quality of the read image is determined, a fourth scan setting screen 300 illustrated in FIG. 17 is displayed on the display 14.

The fourth scan setting screen 300 is a screen for setting the size of the document, and includes a setting area 302, a next icon 304, and a return icon 308.

The setting area 302 is an area for setting the size of the document. Icons 302a to 302h are provided in the setting area 302. The sizes of the document different from each other are assigned to each of the icons 302a to 302f. In addition, setting for automatically detecting the size of the document through a pre-scan performed by the image reading unit 72 is assigned to the icon 302g, for example. Furthermore, setting for manually inputting the size of the document is assigned to the icon 302h. In the fourth scan setting screen 300, the user can set the size of the document by selecting the icons 302a to 302g or manually inputting the size of the document by selecting the icon 302h.

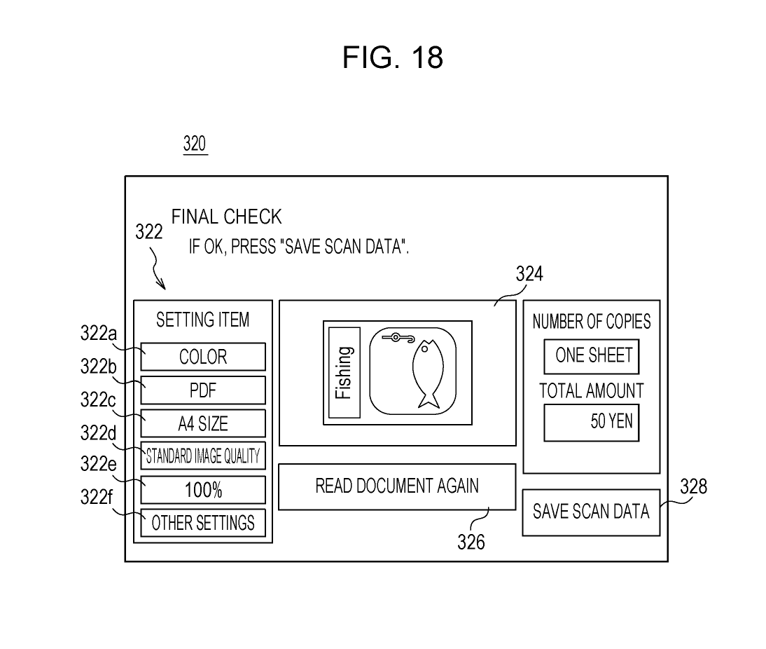

In the fourth scan setting screen 300, when the next icon 304 is touched, the size of the document is determined. When the size of the document is determined, a guide screen for reading the document is displayed on the display 14. Since the guide screen is the same as the first guide screen 180, the second guide screen 200 and the like, the description thereof will be omitted. When the guide screen is instructed to scan the document, a scan check screen 320 illustrated in FIG. 18 is displayed on the display 14.

The scan check screen 320 is a screen for checking and changing the set condition of the job and the like set by the various operation screens described above, and includes a change area 322, a preview area 324, a re-scan icon 326, and a save icon 328g.

The change area 322 is an area for checking and changing the set condition of the job. The change icons 322a to 322f respectively corresponding to setting items are provided in the change area 322. Similarly to the change icons 222a to 222e in the copy check screen 220 described above, when one of the change icons 322a to 322f is touched, a setting change operation screen in order for changing the setting item corresponding to the touched icon is displayed on the display 14 such that the set condition of the job can be changed.

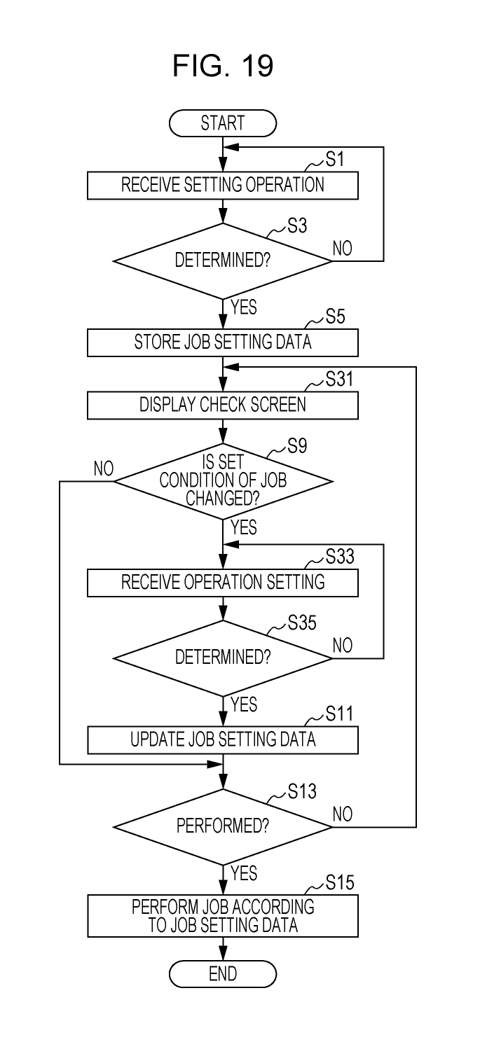

FIG. 19 is a flowchart illustrating an example of information processing in the second embodiment. Hereinafter, the information processing by the information processing apparatus 10 in the second embodiment will be described with reference to the flowchart, however, the processing same as the information processing described in the first embodiment is denoted by the same reference numeral, and the duplicated description will be omitted or briefly described.

As illustrated in FIG. 19, when the information processing is started, the CPU 32 stores the job setting data 504c in the RAM 34 in STEP S5, displays a check screen in STEP S31, and the process proceeds to STEP S9. In STEP S31, for example, the above-described copy check screen 220, the scan check screen 320, and the like are displayed.

Subsequently, if “YES” in STEP S9, that is, if it is determined that the set condition of the job is changed, the setting operation is received in STEP S33, and whether or not the set condition of the job is determined (changed) in STEP S35. In STEP S33, the setting change operation screen is displayed on the display 14 for each setting item, and thus, the set condition of the job can be changed. If “NO” in STEP S35, that is, if it is determined that the set condition of the job is not determined, the process returns to STEP S33. On the other hand, if “YES” in STEP S35, that is, if it is determined that the set condition of the job is determined, the process proceeds to STEP S11.

The contents of the processing up to STEP S5, the processing in STEP S9 and the processing in STEP S11 and thereafter are the same as those in the first embodiment, and the description thereof will be omitted.

According to the second embodiment, after the set condition of the job is set, since the check screen including the preview image is displayed and the change icon is displayed on the check screen, the set condition of the job can be changed after the checking the preview image.

In addition, according to the second embodiment, since the change icon is displayed for each setting item in the check screen, only the setting item the user wants to change can be changed. Therefore, there is no need to perform again the setting for the setting items which will not be changed, and thus, it is possible to improve the convenience.

In the second embodiment, in the check screen, the change icon is displayed for each setting item included in set condition of the job, however, the change icon corresponding to the setting item changed from the initial setting (default setting) may be emphasized to be displayed. For example, a change icon corresponding to the setting item changed from the initial setting may be indicated by a pattern, indicated by an appropriate color, or the contour line of icon may be thickened. In the check screen, only the change icon corresponding to the setting item changed from the initial setting may be displayed. In this case, the change icon corresponding to the setting item which is not changed from the initial setting may be made selectable when the icon to which other functions of changing the set condition is assigned is selected. In this way, the setting item changed from the initial setting becomes easy to understand, and it is easier to check whether the setting is what the user desires or not.

In the second embodiment, the document scanning may be performed in full color regardless of the setting of the color mode. When the color mode is set to black and white, the monochrome (black and white) image data is generated based on the read image data of full color. In this way, even when the color mode is changed by the change icon, the read image data may be processed into monochrome image data, and thus, there is no need to perform the document scanning again. In addition, if the document scanning is performed at high resolution regardless of the set image quality of the read image, even if the image quality setting of the read image is changed by the change icon, the read image data may be processed (resolution adjustment) and thus, there is no need to perform document scanning again. However, in order to realize such an operation, in the information processing program for the information processing apparatus 10 or in the information processing program for the image forming apparatus 70, processing program for processing the read image data is included.

### Third Embodiment

An information processing system 100 according to a third embodiment is similar to that in the first embodiment except that, when a payable amount by the user is not enough at the time of settlement, a notification screen including a change icon is displayed, and thus, only the content different from that in the first embodiment will be described and the redundant description will be omitted.

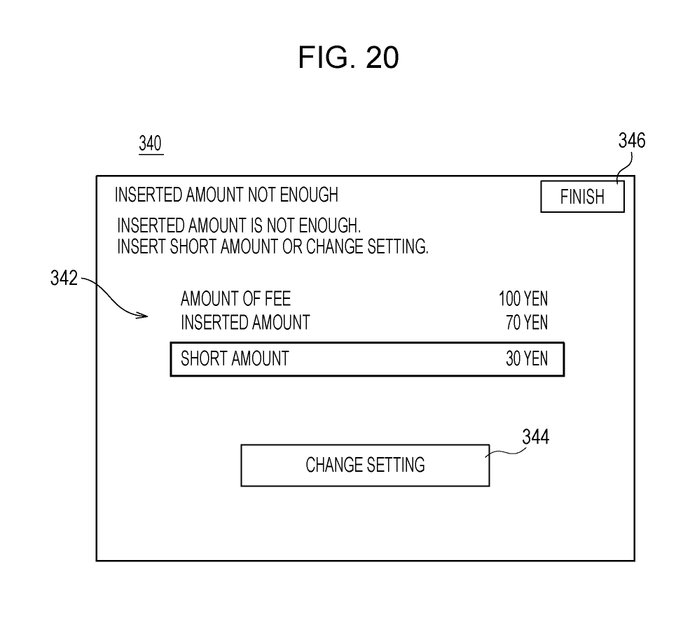

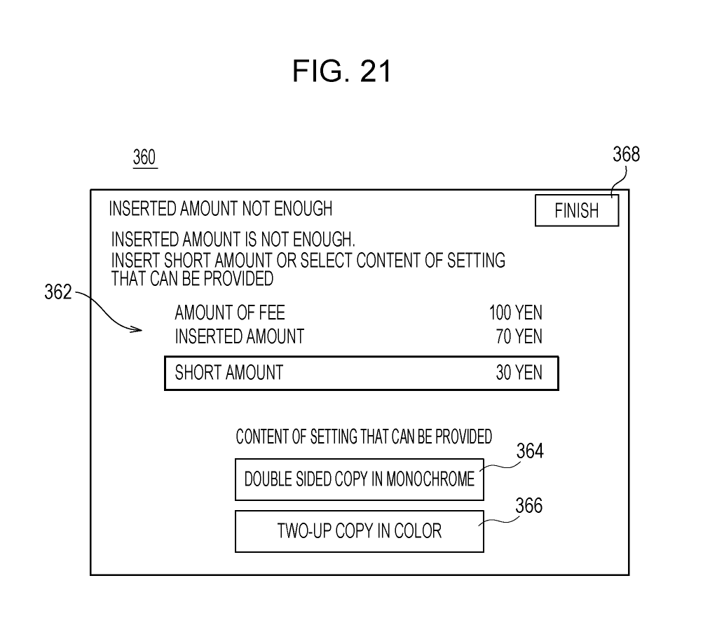

FIG. 20 is an illustrative diagram illustrating an example of a first notification screen 340 in the third example. FIG. 21 is an illustrative diagram illustrating an example of a second notification screen 360 in the third embodiment.

As described in the first embodiment, when the set condition of the job is determined, the settlement screen (not illustrated) is displayed on the display 14. In this settlement screen, the settlement of fee is performed in accordance with the set condition of the job. If the payable amount by the user is equal to or greater than the amount of fee, the settlement can be performed, and when the settlement is completed, the job is performed in accordance with the set condition of the job determined in each operation screen. The payable amount by the user means the inserted amount (the amount of cash inserted into the money insert slot 24a), the balance amount of electronic money and the points of various services. However, at the time of settlement, if the payable amount by the user is not enough for the amount of fee, the settlement is hard to be performed. In this case, in the third embodiment, a notification screen including a change icon is displayed on the display 14. For example, the first notification screen 340 as illustrated in FIG. 20 is displayed on the display 14.

A message indicating that the inserted amount is not enough for the amount of fee, an amount display portion 342, a change icon 344, and a finish icon 346 are provided on the first notification screen 340. In the example illustrated in the first notification screen 340, a case where the balance of electronic money and the points of various services are not used, and thus, the payable amount by the user comes only from the inserted amount, is illustrated.

For example, the first notification screen 340 displays a message such as “The inserted amount is not enough. Insert the short amount or change the setting”.

In the amount display portion 342, the amount of fee, the inserted amount and the short amount according to the set condition of the job are displayed. The same is applied to the amount display portion 362 described later.

A function of changing the set condition of the job is assigned to the change icon 344. For example, if the change icon 344 is touched, the screen returns to the operation screen to set the set condition of the job, and then, the set condition of the job can be changed. Here, the screen may return to the first operation screen to set the set condition of the job or may return to any of the operation screens. Then, by changing the setting item whose amount of fee changes in accordance with the set condition of the job, it is possible to resolve the shortage of inserted amount. For example, in a case of copy job, if the setting of the type of copy job is changed from the “color copy” to the “black and white copy”, or the size of print paper is changed from “A3” to “A4”, the amount of fee decreases, and it is possible to resolve the shortage of the inserted amount without increasing the inserted amount.

A function of closing the first notification screen 340 and returning to the home screen 110 is assigned to the finish icon 346. However, when the finish icon 346 is touched, the set condition of the job is initialized. The same is applied to a finish icon 368 described later.

In addition, if settlement is hard to be performed due to the short of the inserted amount, instead of the first notification screen 340, the second notification screen 360 as illustrated in FIG. 21 may be displayed on the display 14.

A message indicating that the inserted amount is not enough for the amount of fee, an amount display portion 362, a first proposal icon 364, a second proposal icon 366 and a finish icon 368 are provided on the second notification screen 360.

For example, the first notification screen 340 displays a message such as “The inserted amount is not enough. Insert the short amount or change the setting. Select a content of setting that can be provided.”

An automatically generated set condition of the job is assigned to each of the first proposal icon 364 and the second proposal icon 366. However, the set condition of the job assigned to each of the first proposal icon 364 and the second proposal icon 366 is set in such a manner that the amount of fee is equal to or less than the inserted amount. For example, in the example illustrated in FIG. 21, a “double sided copy in monochrome (black and white)” is assigned to the first proposal icon 364 as a set condition of the job. In addition, a “two-up copy in color” is assigned to the second proposal icon 366 as the set condition of the job. When any one of the first proposal icon 364 and the second proposal icon 366 is touched, the set condition of the job is changed to the set condition assigned to the touched icon. In this way, it is possible to resolve the shortage of the inserted amount.

The set condition assigned to the first proposal icon 364 and the second proposal icon 366 illustrated in FIG. 21 is an example, and can be changed as appropriate according to the content of the job that can be provided by the information processing system 100 within the payable amount by the user.

In addition, in the third embodiment, in order to realize the above-described operation, the information processing program for the information processing apparatus 10 includes a fee setting program for setting the fee according to the set condition of the job, a detection program for detecting the payable amount by the user, an amount determination program for determining whether or not the payable amount by the user reaches the amount of fee, a generation program for generating the set condition of the job set in such a manner that the amount of fee is equal to or less than the payable amount by the user, and the like.

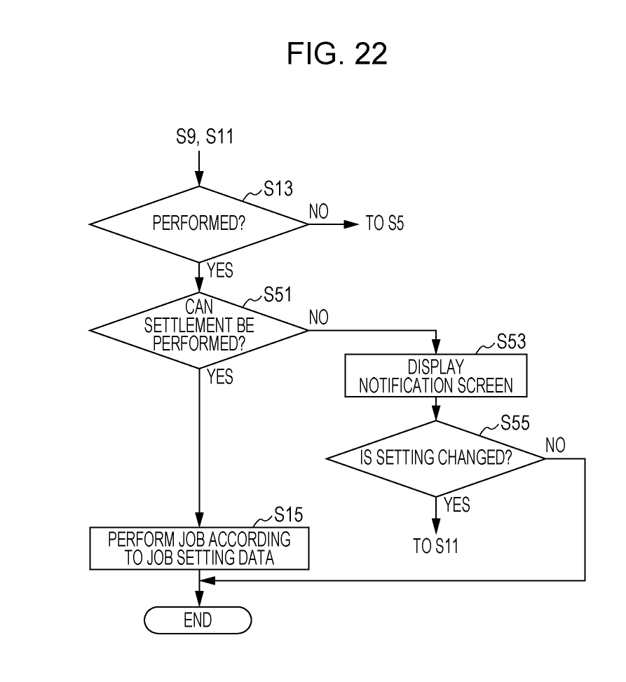

FIG. 22 is a flowchart illustrating an example of the information processing in the third embodiment. Hereinafter, the information processing by the information processing apparatus 10 in the third embodiment will be described using the flowchart, however, the same processing as the information processing described in the first embodiment is denoted by the same reference numeral, and the repeated description will be omitted or briefly described.

As illustrated in FIG. 22, when information processing is started, if “YES” in STEP S13, the CPU 32 determines whether or not the settlement can be performed in STEP S51. Here, the payable amount by the user is compared with the amount of fee, and it is determined whether or not the payable amount by the user reaches the amount of fee.

If “YES” in STEP S51, that is, if it is determined that settlement can be performed, the process proceeds to STEP S15, and the job is performed. On the other hand, if “NO” in STEP S51, that is, if it is determined that the settlement is hard to be performed, in STEP S53, the notification screen including the change icon is displayed on the display 14.

Subsequently, in STEP S55, it is determined whether or not to change the set condition of the job. If “YES” in STEP S55, that is, when the set condition of the job is changed, the process proceeds to STEP S11 and the job setting data 504c is updated. On the other hand, if “NO” in STEP S55, that is, if set condition of the job is not changed, the information processing is ended.

The content of the processing up to STEP S13 and the processing in STEP S15 are the same as those in the first embodiment, and thus, the description thereof will be omitted.

According to the third embodiment, if the payable amount by the user is not enough at the time of settlement, since the notification screen including the change icon is displayed, the set condition of the job can be changed and it is possible to resolve the shortage of payable amount by the user. In addition, since there is no need to perform the setting again from the beginning, and it is possible to improve the convenience.

In addition, according to the third embodiment, if the payable amount by the user is not enough at the time of settlement, since a proposal icon corresponding to the set condition of the job set in such a manner that the amount of fee is equal to or smaller than the payable amount by the user is displayed, it is possible to resolve the shortage of the payable amount by the user with a simple operation.

The aspect described in the third embodiment can also be adopted in combination with the second embodiment.

### Fourth Embodiment

An information processing system 100 according to a fourth embodiment is similar to that in the first embodiment except that, when a user operation that does not correspond to the set condition of the job is received after the set condition of the job is set, a change icon is displayed, and thus, only the content different from that in the first embodiment will be described and the redundant description will be omitted.

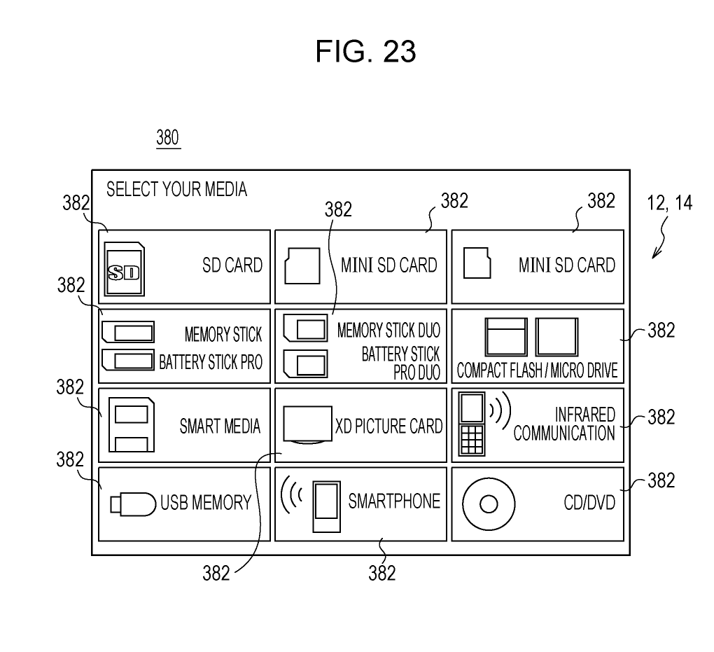

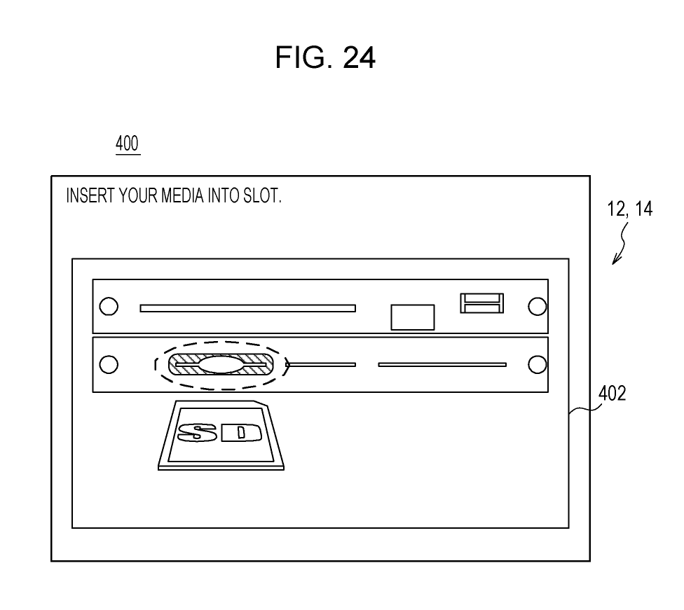

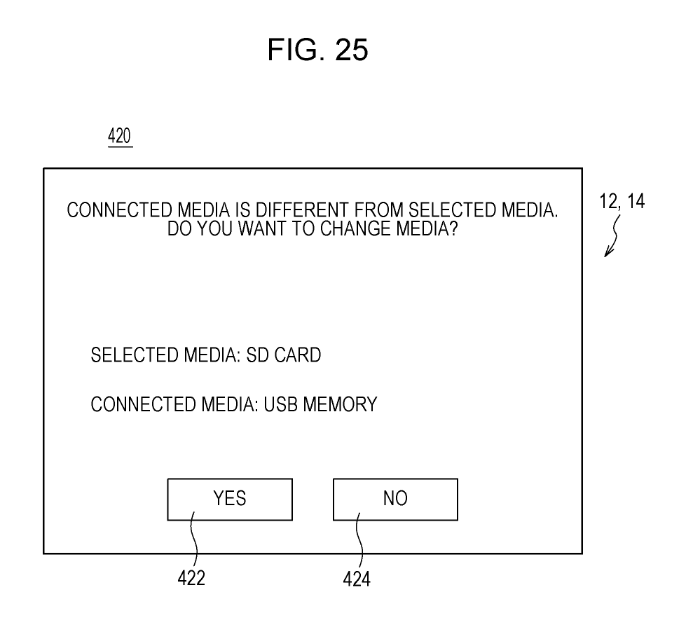

FIG. 23 is an illustrative diagram illustrating an example of a first selection screen 380 in the fourth embodiment. FIG. 24 is an illustrative diagram illustrating an example of a third guide screen 400 in the fourth embodiment. FIG. 25 is an illustrative diagram illustrating an example of a second selection screen 420 in the fourth embodiment.

In the fourth embodiment, when a job using a recording medium (media) is selected, a selection screen for selecting the media used by the user is displayed on the display 14. For example, when an icon 112 to which a job (hereinafter, referred to as a “media print job”) that performs print from the recording medium is touched on the home screen 110, as an operation screen for setting the set condition of the media print job, a first selection screen 380 for selecting the media is displayed on the display 14 as illustrated in FIG. 23.

Selection icons 382 are provided in the first selection screen 380. Each of the selection icons 382 corresponds to the media usable in the information processing system 100 (connectable to the recording medium connection unit 16).

In the first selection screen 380, the media (set media) that the user intends to use is set by touching any one of the selection icons 382. When the set media is set, a third guide screen 400 is displayed on the display 14, as illustrated in FIG. 24.

A message guiding the user to insert (connect) the media and a rectangular shape moving image display area 402 are provided in the third guide screen 400.

A moving image indicating a method of inserting the media is displayed in the moving image display area 402. Specifically, the moving image indicating a position of the setting slot of the set media and the direction of inserting the set media is displayed on the moving image display area 402. However, the moving image is repeatedly played (displayed) until the media is inserted into the memory slot.

When the set media is correctly inserted, that is, when the set media is connected to the recording medium connection unit 16, the information processing apparatus 10 accesses the set media and reads the image data stored in the set media. However, in some cases, media other than the set media may be connected to the recording medium connection unit 16. That is, user operations that do not correspond to set condition of the job may be received. In this case, a second selection screen 420 illustrated in FIG. 25 is displayed on the display 14.

A message indicating that a media different from the set media is connected, a YES icon 422 and a NO icon 424 are provided on the second selection screen 420.

For example, on the second selection screen 420, a message such as “Media different from the selected media is connected. Do you want to change the media?” is displayed. In addition, below this message, a character string indicating the media (SD card) selected by user and connected media (USB memory) is displayed.

A function of changing the set media to the media connected to the recording medium connection unit 16 is assigned to the YES icon 422. That is, the YES icon 422 functions as a change icon for changing the set media. In the example illustrated in FIG. 25, when the YES icon 422 is touched, the information processing apparatus 10 changes the set media to the connected media (USB memory) and reads the image data stored in the USB memory.

A function of returning to the third guide screen 400 without changing the set media is assigned to the NO icon 424. When the NO icon 424 is touched, the second selection screen 420 is closed and the third guide screen 400 is displayed on the display 14.

In the fourth embodiment, in order to realize the above-described operation, the information processing program for the information processing apparatus 10 includes an operation determination program that determines whether or not the user operation performed after the set condition of the job is set is an operation corresponding to the set condition of the job.

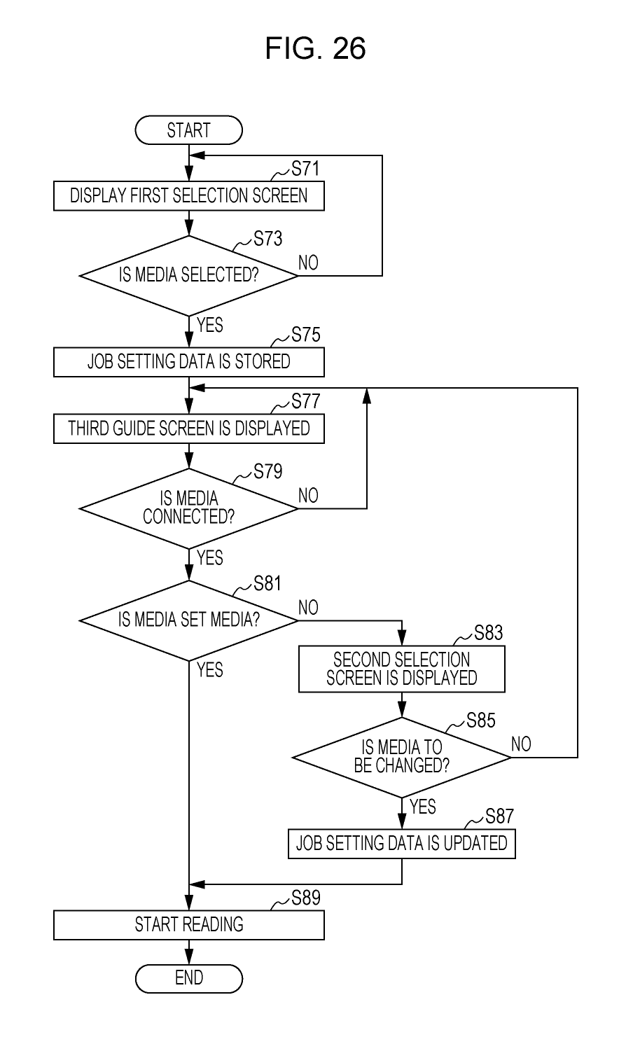

FIG. 26 is a flowchart illustrating an example of information processing in the fourth embodiment. Hereinafter, the information processing by the information processing apparatus 10 in the fourth embodiment will be described using the flowchart. The information processing in the fourth embodiment is started when the job in which the media is used is selected.

As illustrated in FIG. 26, when the information processing is started, the CPU 32 displays the first selection screen 380 on the display 14 in STEP S71, and in STEP S73, determines whether or not the set media is selected. Here, it is determined whether or not any one of the selection icons 382 in the first selection screen 380 is touched.

If “NO” in STEP S73, that is, if it is determined that the set media is not selected, the process returns to STEP S71. On the other hand, if “YES” in STEP S73, that is, if it is determined that the set media is selected, the job setting data 504c is stored in S75, the third guide screen 400 is displayed on the display 14 in STEP S77, and it is determined whether or not the media is connected to the recording medium connection unit 16 in STEP S79.

If “NO” in STEP S79, that is, if it is determined that the media is not connected to the recording medium connection unit 16, the process returns to STEP S77. On the other hand, if “YES” in STEP S79, that is, if it is determined that the media is connected to the recording medium connection unit 16, it is determined whether or not the media connected to the recording medium connection unit 16 is the set media in STEP S81.

If “YES” in STEP S81, that is, if it is determined that the media connected to the recording medium connection unit 16 is the set media, the process proceeds to STEP S89 described later. On the other hand, if “NO” in STEP S81, that is, if it is determined that the media connected to the recording medium connection unit 16 is not the set media, the second selection screen 420 is displayed on the display 14 In step S83, and it is determined whether or not to change the set media to the media connected to the recording medium connection unit 16 in step S85. Here, in the second selection screen 420, it is determined whether the YES icon 422 is selected or not.

If “NO” in STEP S85, that is, if it is determined not to change the set media, the process returns to STEP S77. On the other hand, if “YES” in STEP S85, that is, if it is determined to change the set media to the media connected to the recording medium connection unit 16, the media connected to the recording medium connection unit 16 is set as the set media in STEP S87, the job setting data 504c for the set media is updated, and then, the process proceeds to STEP S89.

Subsequently, in STEP S89, the set media is accessed in accordance with job setting data 504c, and the image data stored in set media is read, and then, the information processing is ended.

According to the fourth embodiment, when the user operation that does not correspond to the set condition of the job is received after the set condition of the job is set, since the change icon is displayed, there is no need to perform the setting again from the beginning, and thus, it is possible to improve the convenience.

According to the fourth embodiment, when the user operation that does not correspond to the set condition of the job is received, since the set condition of the job is changed in accordance with the user operation, the operation for changing the setting becomes simple and convenient.

In the fourth embodiment, an example in which the operation of connecting the media different from the set medium to the recording medium connection unit 16 is described as a user operation that does not correspond to the set condition of the job, but not limited thereto. For example, the aspect in the fourth embodiment can be applied to a case where the copy job and the scan job are selected, a case where the document of a size different from the size of the set document is placed on the document table, and a case where the monochrome document is placed on the document table even though the color mode is set to “full color”.

In addition, the aspect illustrated in the fourth embodiment can be adopted in combination with the second embodiment and the third embodiment.

The numerical values, screens, the specific configurations and the like described in the embodiments described above are mere examples and can be appropriately changed in accordance with the actual products.

In addition, the order of processing in each step of the flowchart illustrated in the embodiment described above can be appropriately changed as long as the same result can be obtained.

Furthermore, in the embodiment described above, the information processing apparatus 10 includes the display 14 with the touch panel 12 and operation screens including the setting change operation screen are displayed on the display 14, but not limited thereto. For example, the image forming apparatus 70 may include the display with the touch panel. In this case, the display 14 with the touch panel 12 in the information processing apparatus 10 may be omitted, or the information processing apparatus 10 may include the display 14 with the touch panel 12 and (both the information processing apparatus 10 and the image forming apparatus 70 may include the display with the touch panel). However, if the display 14 with the touch panel 12 is omitted in the information processing apparatus 10, operation screens are displayed on the display of the image forming apparatus 70. In addition, if both the information processing apparatus 10 and the image forming apparatus 70 include the display with the touch panel, the operation screens may be displayed on each display, or operation screens may be displayed on any one of the displays. If the setting change operation screen is displayed on the display of the image forming apparatus 70, the user can change the set condition of the job in the setting change operation screen by a touch input to the touch panel of the image forming apparatus 70.

The present disclosure contains subject matter related to that disclosed in Japanese Priority Patent Application JP 2017-212192 filed in the Japan Patent Office on Nov. 1, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a touch panel display;
a condition setting unit that sets a set condition for a service provided by the information processing apparatus in response to an input operation on the touch panel display;
a storage unit that stores setting data corresponding to the set condition set by the condition setting unit;
a display control unit that causes a setting change operation screen including a change icon for changing the set condition to be displayed on the touch panel display after the setting data is stored in the storage unit;
a condition changing unit that changes the set condition in accordance with the input operation on the touch panel display when the change icon is selected; and
a condition updating unit that updates the setting data stored in the storage unit in accordance with the set condition changed by the condition changing unit.

2. The information processing apparatus according to claim 1, wherein
the setting change operation screen includes both the change icon and a continue icon for performing the service without changing the set condition.

3. The information processing apparatus according to claim 1, wherein
the setting change operation screen includes a check screen including a preview image corresponding to the set condition, and
the display control unit causes the change icon to be displayed on the check screen.

4. The information processing apparatus according to claim 3, wherein
the set condition includes two or more setting items,
the change icon is provided correspondingly for each of the two or more setting items, and
the display control unit emphasizes and displays, on the check screen, the change icon corresponding to the setting item changed from an initial setting by the condition setting unit.

5. The information processing apparatus according to claim 3, further comprising
an image processing unit, wherein
the storage unit stores the preview image, and
the image processing unit, if the set condition is changed by the condition changing unit, reads the preview image stored in the storage unit and processes the preview image in accordance with the set condition after the change.

6. The information processing apparatus according to claim 1, further comprising:
a fee setting unit that sets a fee for the service provided by the information processing apparatus;
a detection unit that detects a payable amount by a user using the information processing apparatus; and
an amount determination unit that determines whether or not the payable amount detected by the detection unit reaches an amount of the fee, wherein
the display control unit causes the change icon to be displayed on the setting change operation screen if the amount determination unit determines that the payable amount does not reach the amount of the fee.

7. The information processing apparatus according to claim 6, further comprising
a generation unit that generates a proposal set condition set such that the amount of the fee is equal to or smaller than the payable amount if it is determined by the amount determination unit that the payable amount does not reach the amount of the fee, wherein
the change icon includes a proposal icon corresponding to the proposal set condition generated by the generation unit.

8. The information processing apparatus according to claim 1, further comprising:
an operation determination unit that determines whether or not a user operation performed after the set condition is set by the condition setting unit is an operation corresponding to the set condition, wherein
the display control unit causes the change icon to be displayed on the setting change operation screen if the operation determination unit determines that the user operation is an operation not corresponding to the set condition.

9. A non-transitory recording medium storing a control program for an information processing apparatus including a touch panel display and a storage, the control program causing a processor of the information processing apparatus to function as:
a condition setting unit that sets a predetermined set condition for the information processing apparatus in response to an input operation on the touch panel display;
a storage unit that causes the storage to store setting data corresponding to the set condition set by the condition setting unit;
a display control unit that causes a setting change operation screen including a change icon for changing the set condition to be displayed on the touch panel display after the setting data is stored in the storage;
a condition changing unit that changes the set condition in accordance with the input operation on the touch panel display when the change icon is selected; and
a condition updating unit that updates the setting data stored in the storage in accordance with the set condition changed by the condition changing unit.

10. A control method executable by a processor of an information processing apparatus including a touch panel display and a storage, the method comprising:
setting a predetermined set condition for the information processing apparatus in response to an input operation on the touch panel display;
causing the storage to store setting data corresponding to the set condition;
causing a setting change operation screen including a change icon for changing the set condition to be displayed on the touch panel display after the setting data is stored in the storage;
changing the set condition in accordance with a user operation when the change icon is selected; and
updating the setting data stored in the storage in accordance with the set condition after the change.
